(19) United States
(12) Patent Application Publication
(10) Pub. No.: US 2026/0009423 A1
(43) Pub. Date: Jan. 8, 2026

(54) BEARING ARRANGEMENT, WHEEL HEAD AND COMMERCIAL VEHICLE DRIVE AXLE

(71) Applicant: ZF Friedrichshafen AG, Friedrichshafen (DE)

(72) Inventors: Martin Lang, Wegscheid (DE); Thomas Waim, Grafenau (DE)

(73) Assignee: ZF Friedrichshafen AG, Friedrichshafen (DE)

(21) Appl. No.: 19/257,888

(22) Filed: Jul. 2, 2025

(30) Foreign Application Priority Data
Jul. 3, 2024 (DE) 10 2024 206 267.7

(51) Int. Cl. F16C 19/18; F16C 33/36; F16C 33/58

(52) U.S. Cl. CPC F16C 19/18; F16C 33/366; F16C 33/583; F16C 2326/02

(57) ABSTRACT

A bearing arrangement for a wheel head of a commercial vehicle drive axle has a bearing with an inner ring arranged on a first component that is located radially inwardly thereof. A second component is mounted on the first component and bas a foot with an inner profile on which the second component is guided in a rotationally fixed and axially displaceable manner on the outer profile of the first component, which is axially adjacent to the bearing location. The second component has an axially aligned abutment surface that abuts an end face of the inner ring, where the abutment surface is radially outward and axially recessed relative to an axial end. The foot of the second component protrudes into a recess on the side of the inner ring. The recess on the inner ring is radially inward of the end face of the inner ring.

### RELATED APPLICATIONS

This application claims the benefit of and right of priority under 35 U.S.C. § 119 to German Patent Application no. 10 2024 206 267.7, filed on 3 Jul. 2024, the contents of which are incorporated herein by reference in its entirety.

### FIELD OF THE DISCLOSURE

The invention relates to a bearing arrangement, in particular for a wheel head of a commercial vehicle drive axle, comprising a bearing with an inner ring which is arranged at a bearing location on a first component located radially inwardly thereof, wherein a second component is mounted on the first component, which is provided radially inwardly at a foot with an inner profile, on which the second component is guided in a rotationally fixed and axially displaceable manner on an outer profile of the first component, and wherein the outer profile on the first component is designed axially adjacent to the bearing location and the second component abuts axially against an end face of the inner ring with an axially aligned abutment surface. Furthermore, the invention relates to a wheel head and a commercial vehicle drive axle.

### BACKGROUND

In drive axles of motor vehicles, it is common practice to couple drive shafts within the respective drive axle with corresponding wheel hubs, each of which serves to attach at least one corresponding vehicle wheel. In commercial vehicle drive axles, wheel heads with wheel hub gears are often provided, each of which can be used to achieve an additional transmission ratio in the power flow between the respective drive shaft and the associated wheel hub. A wheel hub gear is usually designed as a planetary gear, one of whose components is permanently fixed to a housing part and one is permanently connected to the respective drive shaft in a rotationally fixed manner, while the associated wheel hub, together with the remaining component of the planetary gear that is connected to it in a rotationally fixed manner, is mounted in a bearing arrangement so that it can rotate relative to the housing part.

DE 10 2012 208 921 A1 discloses a wheel head for a commercial vehicle drive axle, wherein a drive shaft in such wheel heads is coupled to a wheel hub via an intermediate planetary gear. The planetary gear has a sun gear, a planetary carrier, and a hollow gear, wherein the planetary carrier rotatably supports several planetary gears, each of which is in tooth engagement with both the sun gear and the hollow gear. While the planetary carrier is connected to the wheel hub in a rotationally fixed manner, the sun gear is connected to the drive shaft in a rotationally fixed manner. Furthermore, the wheel hub is rotatably mounted on the housing part in a bearing arrangement, wherein two tapered roller bearings are provided in this bearing arrangement to provide an angled bearing arrangement. One of these tapered roller bearings is arranged axially directly adjacent to the hollow gear and sits with an inner ring on the housing part located radially inwardly thereof. The hollow gear is equipped with an inner profile in the form of a drive gear on one foot, on which the hollow gear is guided in a rotationally fixed and axially displaceable manner on an outer profile of the housing part, which is also designed as a drive gear. The hollow gear is thus permanently fixed in place, with the hollow gear being preloaded against the inner ring of the adjacent tapered roller bearing via a slot nut on the drive gear of the housing part.

### SUMMARY

Based on the prior art described above, the present invention is now tasked with creating a bearing arrangement in which the bearing is as compact as possible in the axial direction, while also providing a load-bearing and rotationally fixed connection between the components of the bearing arrangement.

This object is achieved by a bearing arrangement, a wheel head, and a commercial vehicle drive axle as variously disclosed herein. Additional embodiments and advantageous further developments will be apparent from the present disclosure.

According to the invention, a bearing arrangement comprises a bearing with an inner ring which is arranged at a bearing location of a first component located radially inwardly thereof. A second component is also mounted on the first component, which is provided with an inner profile on one foot inwardly thereof, on which the second component is guided in a rotationally fixed and axially displaceable manner on an outer profile of the first component. The outer profile of the first component is designed on the first component axially adjacent to the bearing location, wherein the second component axially abuts against an abutment surface on an end face of the inner ring.

The bearing arrangement according to the invention therefore comprises a bearing whose inner ring is placed on a first component in the bearing arrangement. The bearing of the bearing arrangement is preferably a rolling bearing, although a design as a plain bearing would also be conceivable within the scope of the invention. The inner ring is preferably placed on the first component at a bearing location, which is designed on the first component in particular as a corresponding, wave-shaped shoulder for accommodating the inner ring. Preferably, the first component is mounted via the bearing so that it can rotate relative to another component, wherein the first component is preferably a permanently fixed component, relative rotation of the other component via the bearing being permitted. In this case, the permanently fixed first component can then be a housing part, which is designed in particular to be pin-shaped.

Axially adjacent to the inner ring receptacle, the first component is also connected to a second component in a rotationally fixed manner, wherein this rotationally fixed connection is achieved by means of drive profiles. For this purpose, an outer profile is formed on the first component axially adjacent to the bearing location, i.e., a profile projecting radially outward, on which the second component is guided by means of an inner profile. This inner profile is a profile that protrudes radially inward and is defined at one foot of the second component. With this foot, the second component is equipped on a radial inner side. The interaction between the outer profile of the first component and the inner profile of the second component ensures that the second component is guided on the first component in a rotationally fixed manner and moved axially. The outer profile and inner profile are particularly preferred designs for drive gear.

The outer profile is designed on the first component axially adjacent to the bearing location, wherein the outer profile and the bearing location are separated axially from one another in particular only by an intermediate undercut.

Axial contact is established between the inner ring and the second component by the second component abutting against an axially aligned abutment surface on an axially aligned end face of the inner ring. In particular, this is achieved in order to apply axial preload to the inner ring on the first component via the second component. The second component is particularly preferred to be pressed axially in the direction of the inner ring onto the outer profile of the first component by means of a clamping device, in particular in the form of at least one clamping nut, and thereby lies axially with its abutment surface against the end face of the inner ring.

In the context of the invention, “axial” refers to a parallel direction to the axes of rotation of the first component, the second component, and the inner ring, while “radial” refers to a direction in the diameter direction of the first component, the second component, or the inner ring.

The invention now comprises the technical teaching that the abutment surface is designed radially outward and axially recessed relative to an axial end with which the foot of the second component protrudes into a recess on the inner ring side. The recess on the inner ring is designed to be radially inward of the end face of the inner ring. In other words, the abutment surface at which the second component axially abuts against the end face of the inner ring is radially outward with respect to the foot of the second component and is also axially offset from an axial end of the foot, whereby this axial end of the foot protrudes axially relative to the abutment surface. However, axial contact between the abutment surface of the second component and the end face of the inner ring is still possible because the axial end of the foot on the inner ring side projects into a recess provided on the inner ring so that the inner ring is radially inward of its end face.

This type of bearing arrangement has the advantage that the axial contact between the second component and the inner ring is thus achieved in axial overlap with the foot and therefore also with the guide of the second component on the first component. This allows the second component to move axially closer to the inner ring without having to shorten the axial length of the guide of the second component with its inner profile on the outer profile of the first component. Overall, this results in an axially compact bearing arrangement with reliable rotationally fixed guidance of the second component on the first component, while at the same time providing preload on the inner ring via the second component.

According to one embodiment of the invention, the bearing is designed as a double-row rolling bearing, wherein the inner ring is provided with a further recess on an end face located axially opposite the second component, in which a sealing ring located between the inner ring and the first component is accommodated. This enables a reliable seal to be achieved between the inner ring and the first component on the side facing away from the second component in the axial direction. In particular, this prevents contaminants from penetrating between the inner ring and the first component.

In a further development of the invention, the inner ring is formed by two identical inner ring parts, which are assembled in a mirrored arrangement to form the inner ring and in which the recess and the further recess are identically designed. This is a cool way to make the bearing arrangement in this invention with low manufacturing costs, since the recess in the inner ring for the axial end of the foot to go into is already there for the sealing ring because the inner ring parts are built the same. The two inner ring parts are preferably held together by a retaining clip, which allows the bearing arrangement according to the invention to be mounted in a simple manner.

The double-row rolling bearing is particularly preferred in the form of a double-row tapered roller bearing, which is then used in particular to provide an angled support bearing. The double-row tapered roller bearing preferably implements an O arrangement, although an X arrangement would also be conceivable.

According to one embodiment of the invention, the abutment surface of the second component is formed by a cutout which is formed around the circumference of the second component, extending radially outward from an axial end face of the second component toward the foot. This allows the axially recessed and radially outwardly located design of the abutment surface to be reliably achieved. The cutout is preferably designed as a radially outwardly open shoulder on the second component.

Another embodiment of the invention is that the recess of the inner ring is designed as a circumferential slot. This advantageously creates a space on the inner ring into which the foot of the second component can be inserted with its axial end.

The invention also relates to a wheel head comprising a wheel hub, an output shaft, and a planetary gear. The planetary gear has several elements in the form of a sun gear, a hollow gear, and a planetary carrier, wherein one of the elements of the planetary gear is connected in a rotationally fixed manner to the drive shaft, one of the elements of the planetary gear is connected in a rotationally fixed manner to the wheel hub, and one of the elements of the planetary gear is connected in a rotationally fixed manner to a housing part. The wheel hub is mounted in a bearing arrangement according to one or more of the variants described above so that it can rotate relative to the housing part, wherein in this bearing arrangement, the housing part forms the first component, and the element of the planetary gear connected to the housing part in a rotationally fixed manner forms the second component. This allows for an axially compact design of the wheel hub bearing arrangement in this wheel head, thereby reducing the overall axial length of the wheel head.

In the aforementioned wheel head, it is preferred that the sun gear of the planetary gear is connected to the drive shaft in a rotationally fixed manner, while the planetary carrier of the planetary gear is connected to the wheel hub in a rotationally fixed manner and the hollow gear of the planetary gear is connected to a housing part in a rotationally fixed manner. In this case, the second component of the bearing arrangement is the hollow gear of the planetary gear.

Within the scope of the invention, two wheel heads as described above are provided in particular for a commercial vehicle drive axle, which is in particular an electrically drivable axle.

### BRIEF DESCRIPTION OF THE DRAWINGS

Advantageous embodiments of the invention, which is discussed in the following, is shown in the drawings. The figures show:

FIG. 1: a sectional view of part of a commercial vehicle drive axle in the area of a wheel head designed according to the invention;

FIG. 2: a detailed view of the wheel head from FIG. 1, shown in the area of a bearing arrangement according to a preferred embodiment of the invention;

FIG. 3: a perspective view of a single hollow gear of the bearing arrangement shown in FIG. 2; and

FIG. 4: a perspective view of a single bearing of the bearing arrangement shown in FIG. 2.

### DETAILED DESCRIPTION

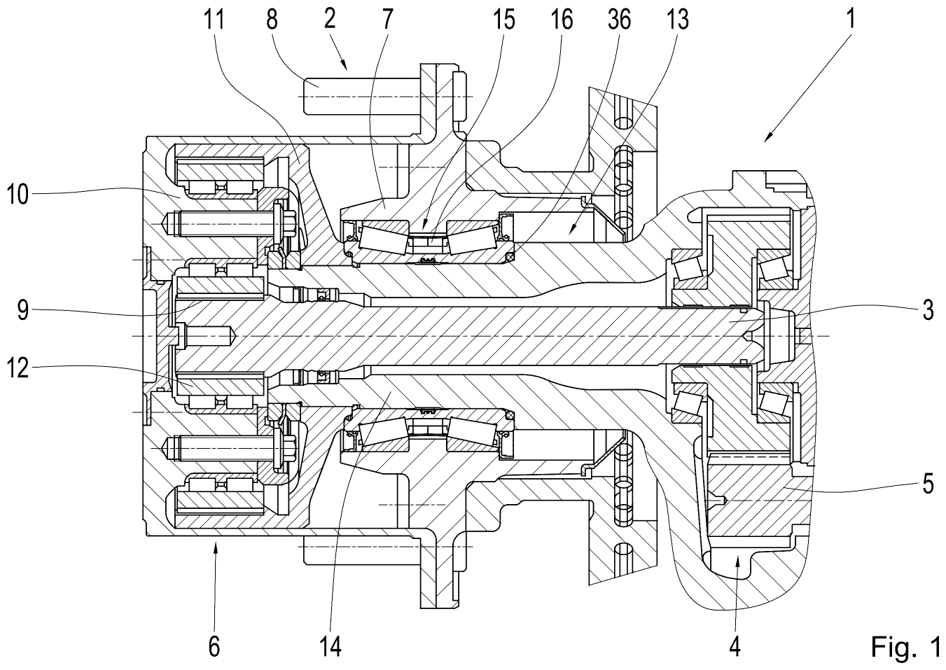

FIG. 1 shows a sectional view of part of a commercial vehicle drive axle 1, wherein the commercial vehicle drive axle 1 is shown in the area of a wheel head 2. The wheel head 2 is assigned a drive shaft 3, which is coupled to a shaft 5 on a side facing away from the wheel head 2 via a spur gear stage 4. The shaft 5 serves to initiate a drive torque, preferably a drive torque from an electric motor, so that the commercial vehicle drive axle 1 is then designed as an electrically drivable axle.

At one end opposite the spur gear stage 4, the output shaft 3 is coupled via a planetary gear 6 to a wheel hub 7, which is designed in the manner of a bell hub and has several wheel bolts 8 on its outer circumference. The wheel bolts 8 are used to secure at least one drive wheel to the wheel hub 7.

The planetary gear 6 has several elements in the form of a sun gear 9, a planetary carrier 10, and a hollow gear 11, wherein the planetary carrier 10 rotatably supports several planetary gears 12, each of which is in tooth engagement with both the sun gear 9 and the hollow gear 11. While the sun gear 9 is designed as a single piece with the drive shaft 3, the planetary carrier 12 is connected to the wheel hub 7. In this respect, there is a rotationally fixed connection between the sun gear 9 and the drive shaft 3 on the one hand, and between the planetary carrier 10 and the wheel hub 7 on the other. In contrast, the hollow gear 11 is connected in a rotationally fixed manner to a housing part 13, which is a gantry housing pin 14.

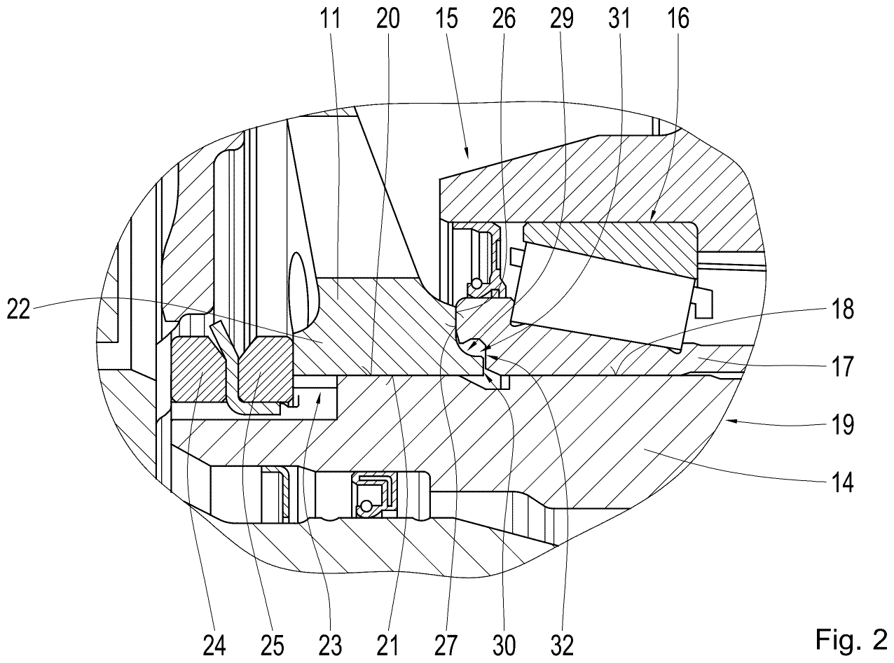

The wheel hub 7 is rotatably mounted on the gantry housing pin 14 in a bearing arrangement 15, which bearing arrangement 15 is designed in accordance with a preferred embodiment of the invention and is shown in more detail in FIG. 2. The wheel hub 7 is mounted via a bearing 16, which is shown in full in FIG. 1 and partially shown in FIG. 2, and which is designed as a double-row rolling bearing in the form of a double-row tapered roller bearing in an O arrangement.

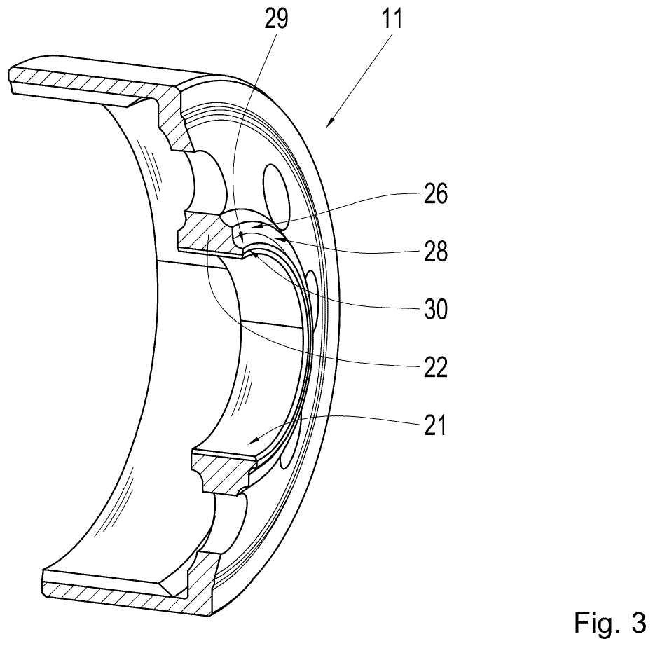

As can be seen in particular in FIG. 2, an inner ring 17 of the bearing 16 is arranged on a bearing location 18 of the gantry housing pin 14, which thereby forms a component 19 of the bearing arrangement 15 according to the invention. Axially adjacent to the bearing location 18, the gantry housing pin 14 is also provided with an outer profile 20, which is separated from the bearing location by an intermediate undercut and is designed as a drive gear. On this outer profile 20, the hollow gear 11 is guided by an inner profile 21, which is designed as a counter-toothing to the outer profile 20 and thus, in conjunction with the outer profile 20, provides axially displaceable and rotationally fixed guidance of the hollow gear 11 on the gantry housing pin 14. The inner profile 21, as can be seen in particular in FIG. 3 from a single view of the hollow gear 11, is designed on a foot 22, with which the hollow gear 11 is provided radially on the inside for guidance on the gantry housing pin 14.

In bearing arrangement 15, the hollow gear 11 forms a further component 23, in that the hollow gear 11 provides axial preload for the inner ring 17 of the bearing 16. This axial preload is applied via slot nuts 24 and 25, which are screwed together onto a thread at one end of the gantry housing pin 14 and preload the hollow gear 11 with an axial abutment surface 26 against an end face 27 of the inner ring 17.

As a special feature, the abutment surface 26 on the hollow gear 11 is formed by a circumferential cutout 28, which can be seen in FIG. 3, which is introduced radially outward from an axial end face of the hollow gear 11 toward the foot 22 and thereby forms a shoulder 29 radially outward from the foot 22. As a result, the abutment surface 26 is located radially outward and axially set back relative to an axial end 30 of the foot 22, whereby the abutment surface 26 lies axially overlapping the inner profile 20 at the hollow gear 11. This also means that the contact between abutment surface 26 and end face 27 of inner ring 17 is axially covered by the guide of the hollow gear 11 on the outer profile 20 of the gantry housing pin 14.

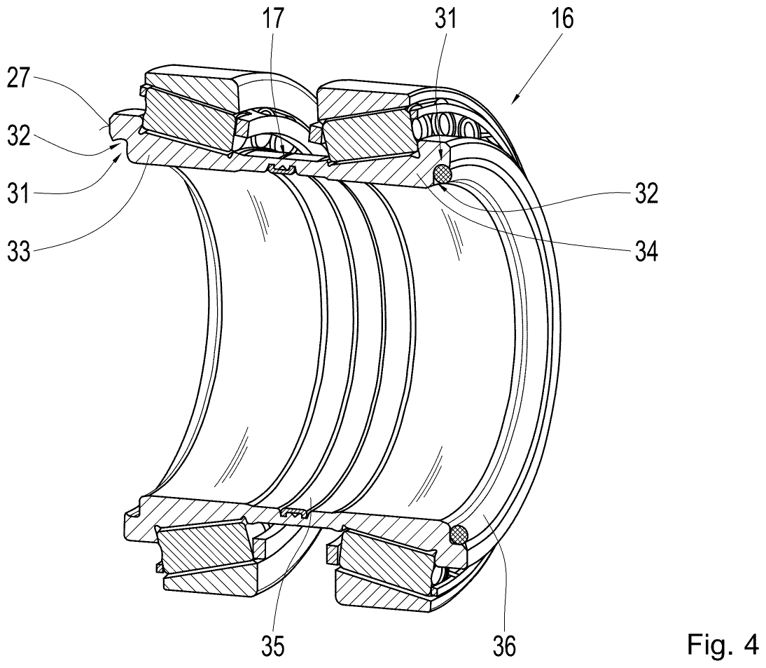

In addition, a recess 31 is formed on the inner ring 17, into which the axial end 30 of the foot 22 can axially engage during axial contact between the abutment surface 26 and the end face 27. This recess 31 is designed as a circumferential slot 32 which, as can be seen in particular in the perspective view of the bearing 16 in FIG. 4, is radially inwardly located relative to the end face 27 on the inner ring 17.

Due to the axial overlap of the contact between abutment surface 26 and end face 27 with the guide for hollow gear 11 on the gantry housing pin 14, which is achieved by means of outer profile 20 and inner profile 21, hollow gear 11 can be positioned axially closer to bearing 16, thereby reducing the axial overall length of wheel head 2 accordingly. This is achieved without axially shortening the engagement length between the outer profile 20 and the inner profile 21.

As can be seen in FIG. 4, the inner ring 17 of the bearing 16 is formed by two inner ring parts 33 and 34, which are identical to each other and are assembled to form the inner ring 17 by mirrored arrangement. The two inner ring parts 33 and 34 are held together by a retaining clip 35 to simplify mounting of the inner ring 17 on the gantry housing pin 14.

Due to the identical design of the two inner ring parts 33 and 34, both inner ring parts 33 and 34 are also provided with the recess 31 designed as a slot 32, which in the bearing 16 is actually intended to allow a sealing ring 36 to be placed between the inner ring 17 and the gantry housing pin 14. This sealing ring can be seen in FIG. 1 as well as in FIG. 4. Since the recess 31 is already present in the inner ring part 33 due to the identical structure of the two inner ring parts 33 and 34, only a modification to the hollow gear 11 is required to reduce the axial length of the wheel head 2. This means that this reduction in overall length can also be achieved with low manufacturing costs

Overall, a bearing arrangement can therefore be created for a wheel head by means of the embodiment according to the invention, which enables an axially compact bearing of a wheel hub and in which a reliable rotationally fixed connection of an element of a planetary gear is also realized with a gantry pin housing.

### REFERENCE NUMBERS

1 commercial vehicle drive axle
2 wheel head
3 drive shaft
4 spur gear stage
5 shaft
6 planetary gear
7 wheel hub
8 wheel bolts
9 sun gear
10 planetary carrier
11 hollow gear
12 planetary gears
13 housing part
14 gantry housing pin
15 bearing arrangement
16 bearing
17 inner ring
18 bearing location
19 component
20 outer profile
21 inner profile
22 foot
23 component
24 slot nut
25 slot nut
26 abutment surface
27 end face
28 cutout
29 shoulder
30 end
31 recess
32 slot
33 inner ring part
34 inner ring part
35 retaining clip
36 sealing ring

1. A bearing arrangement (15) for a wheel head (2) of a commercial vehicle drive axle (1), comprising:
a first component (19) having an outer profile (20);
a second component (23) mounted on the first component (19),
a bearing (16) with an inner ring (17) arranged at a bearing location (18) of the first component (19) located radially inwardly thereof;
wherein the second component (23) defines a foot (22) radially inward and has an inner profile (21) on which the second component (23) is guided in a rotationally fixed and axially displaceable manner on the outer profile (20) of the first component (19);
wherein the outer profile (20) is formed on the first component (19) axially adjacent to the bearing location (18);
wherein the second component (23) abuts axially against an end face (27) of the inner ring (17) with an axially aligned abutment surface (26);
wherein the abutment surface (26) is radially outward and axially recessed relative to an axial end (30) with which the foot (22) of the second component (23) protrudes into a recess (31) on the side of the inner ring (21); and
wherein the recess (31) on the inner ring (17) is designed radially inwardly of the end face (27) of the inner ring (17).

2. The bearing arrangement (15) according to claim 1, wherein the bearing (16) is configured as a double-row rolling bearing, wherein the inner ring (17) is provided on an end face located axially opposite the second component (23) and defines a further recess (31), in which a sealing ring (36) is accommodated between the inner ring (17) and the first component (19).

3. The bearing arrangement (15) according to claim 2, wherein the inner ring (17) is formed by two identical inner ring parts (33, 34) which are assembled in a mirrored arrangement with respect to the inner ring (17) and in which the recess (31) and the further recess (31) are identically defined.

4. The bearing arrangement (15) according to claim 3, further comprising a retaining clip (35), wherein the inner ring parts (33, 34) are held together by the retaining clip (35).

5. The bearing arrangement (15) according to claim 2, wherein the double-row rolling bearing is configured as a double-row tapered roller bearing.

6. The bearing arrangement (15) according to claim 1, wherein the abutment surface (26) of the second component (23) is formed by a cutout (28) which goes around the circumference from an axial end face of the second component (23) radially outwardly toward the foot (22).

7. The bearing arrangement (15) according to claim 6, wherein the cutout (28) is configured as a shoulder (29) open radially outward on the second component (23).

8. The bearing arrangement (15) according to claim 1, wherein the recess (31) of the inner ring (17) is configured as a circumferential slot (32).

9. A wheel head (2) for a commercial vehicle drive axle (1), comprising:
a wheel hub (7);
a drive shaft (3); and
a planetary gear (6) having elements in the form of a sun gear (9), a hollow gear (11), and a planetary carrier (10), wherein one of the elements of the planetary gear (6) is connected in a rotationally fixed manner to the drive shaft (3), one of the elements of the planetary gear (6) is connected in a rotationally fixed manner to the wheel hub (7), and one of the elements of the planetary gear (6) is connected in a rotationally fixed manner to a housing part (13);
wherein the wheel hub (7) is mounted in the bearing arrangement (15) according to claim 1 in a rotationally fixed manner relative to the housing part (13); and
wherein, in the bearing arrangement (15), the housing part (13) forms the first component (19) and the element of the planetary gear (6) connected in a rotationally fixed manner to the housing part (13) forms the second component (23).

10. The wheel head (2) according to claim 9, wherein the sun gear (9) of the planetary gear (6) is connected in a rotationally fixed manner to the drive shaft (3), the planetary carrier (10) of the planetary gear (6) is connected in a rotationally fixed manner to the wheel hub (7), and the hollow gear (11) of the planetary gear (6) is connected in a rotationally fixed manner to a housing part (13).

11. A commercial vehicle drive axle (1) comprising two wheel heads (2) each comprising:
a wheel hub (7);
a drive shaft (3); and
a planetary gear (6) having elements in the form of a sun gear (9), a hollow gear (11), and a planetary carrier (10), wherein one of the elements of the planetary gear (6) is connected in a rotationally fixed manner to the drive shaft (3), one of the elements of the planetary gear (6) is connected in a rotationally fixed manner to the wheel hub (7), and one of the elements of the planetary gear (6) is connected in a rotationally fixed manner to a housing part (13);
wherein the wheel hub (7) is mounted in the bearing arrangement (15) according to claim 1 in a rotationally fixed manner relative to the housing part (13); and
wherein, in the bearing arrangement (15), the housing part (13) forms the first component (19) and the element of the planetary gear (6) connected in a rotationally fixed manner to the housing part (13) forms the second component (23).

12. The commercial vehicle drive axle according to claim 11, wherein the sun gear (9) of the planetary gear (6) is connected in a rotationally fixed manner to the drive shaft (3), the planetary carrier (10) of the planetary gear (6) is connected in a rotationally fixed manner to the wheel hub (7), and the hollow gear (11) of the planetary gear (6) is connected in a rotationally fixed manner to a housing part (13).
